(19) United States
(12) Patent Application Publication
(10) Pub. No.: US 2013/0100047 A1
(43) Pub. Date: Apr. 25, 2013

(54) TOUCH DISPLAY DEVICE

(71) Applicants: Chin-Yueh Liao, Taipei City (TW); Ping-Hwan Lee, Taipei City (TW); Tsung-Shou Chin, Kaohsiung City (TW); Wei-Hung Kuo, Hsinchu County (TW); Seok-Lyul Lee, Hsinchu City (TW)

(72) Inventors: Chin-Yueh Liao, Taipei City (TW); Ping-Hwan Lee, Taipei City (TW); Tsung-Shou Chin, Kaohsiung City (TW); Wei-Hung Kuo, Hsinchu County (TW); Seok-Lyul Lee, Hsinchu City (TW)

(73) Assignee: AU OPTRONICS CORPORATION, Hsinchu (TW)

(21) Appl. No.: 13/352,355

(22) Filed: Jan. 18, 2012

(30) Foreign Application Priority Data
Oct. 24, 2011 (TW) 100138475

(51) Int. Cl. G06F 3/041

(52) U.S. Cl. 345/173

(57) ABSTRACT

A touch display device is provided. The touch display device includes a touch panel, a display panel, an anti-splinted film and a transparent conductive layer. The anti-splinted film is disposed between the touch panel and the display panel. The transparent conductive layer is disposed between the display panel and the anti-splinted film.

### CROSS-REFERENCE TO RELATED APPLICATION

This application claims the priority benefit of Taiwan application serial no. 100138475, filed on Oct. 24, 2011. The entirety of the above-mentioned patent application is hereby incorporated by reference herein and made a part of this specification.

### BACKGROUND OF THE INVENTION

1. Technical Field

The invention relates to a display device, more particularly to a touch display device.

2. Background

The increasing progress of display technologies brings about great conveniences to people's daily life. Such as, flat panel displays (FPDs) have become popular due to its features of being light and thin. Recently, all types of electronic products are developed toward easy operation, small volume, and large screen. The demands of the volume and the screen size in the portable products are particularly stringent. Besides, in many electronic products, a touch sensing design is integrated into a display panel, so as to expand the area where the screen is disposed by removing the space for placing the keyboard or the operation buttons.

Generally speaking, a touch display panel includes a display panel and a touch panel, wherein the touch panel can be built in the display panel or attached on the display panel. Based on different ways of sensing, touch panels are generally categorized into resistant touch panels, capacitive touch panels, optical touch panels, sonic wave touch panels, and electromagnetic touch panels. The capacitive touch panels having advantages of fast response speed, favorable reliability, and durability have been extensively in electronic devices.

The capacitive touch panels usually have a plurality of sensing series insulated from each other, and each sensing series has a plurality of sensing pads. When a finger touches the touch panel, the capacitance between the sensing pads is changed. The change of capacitance is transformed into a control signal, transmitted to a control circuit board, and arithmetically processed. After that, a proper instruction is output to operate the electronic device. However, since the data lines of the display panel are used to transmit data signals, the data lines of the display panel may couple with the sensing pads when a high voltage is applied on the data lines. That is, the sensing signals received by the sensing pads may be seriously interfered. Accordingly, a signal to noise ratio (SNR) in the touch panel is declined, and the sensing capacity is deteriorated.

### SUMMARY

An exemplary embodiment of the invention provides a touch display device, which reduces signal interference between the touch panel and the display panel.

An exemplary embodiment of the invention provides a touch display device, which includes a touch panel, a display panel, an anti-splinted film and a transparent conductive layer. The anti-splinted film is disposed between the touch panel and the display panel. The transparent conductive layer is disposed between the display panel and the anti-splinted film.

An exemplary embodiment of the invention provides a touch display device, which includes a touch panel, a display panel, a transparent substrate and a transparent conductive layer. The transparent substrate is disposed between the touch panel and the display panel. The transparent conductive layer is disposed between the transparent substrate and the display panel.

According to the touch display device of the invention, the transparent conductive layer is disposed between the touch panel and the display panel, and therefore signal interference between the touch panel and the display panel is reduced. Accordingly, the signal to noise ratio (SNR) and the sensing capacity of the touch display device are improved.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic cross-sectional view illustrating a touch display device according to a first embodiment of the invention.

FIG. 2 is a schematic cross-sectional view illustrating a touch display device according to a second embodiment of the invention.

FIG. 3 is a schematic cross-sectional view illustrating a touch display device according to a third embodiment of the invention.

### DETAILED DESCRIPTION OF DISCLOSED EMBODIMENTS

### First Embodiment

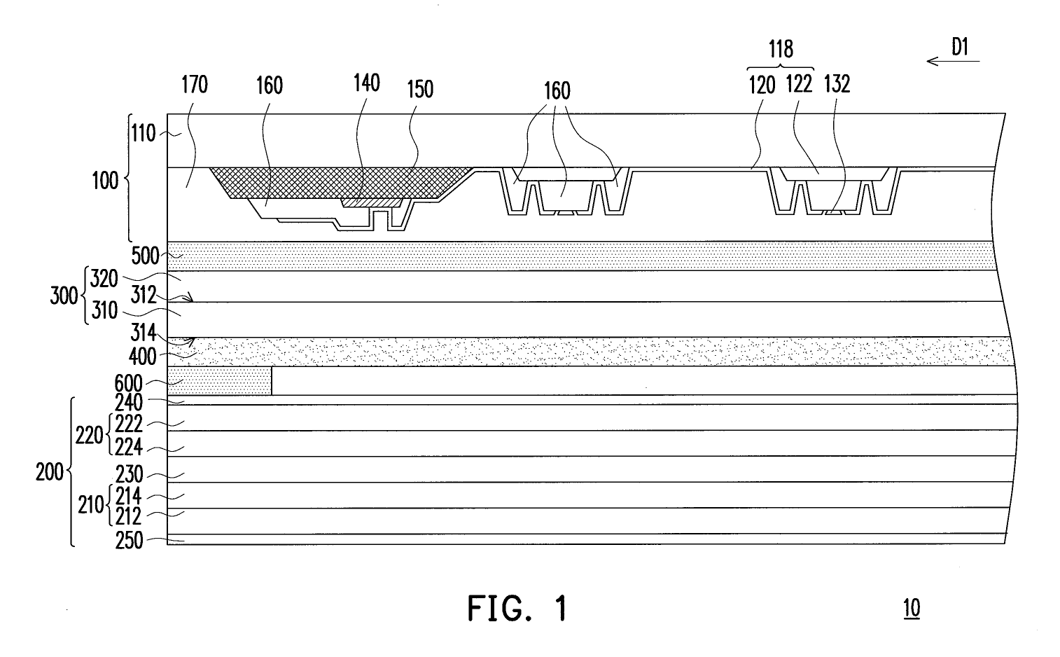

FIG. 1 is a schematic cross-sectional view illustrating a touch display device according to a first embodiment of the invention. Referring to FIG. 1, a touch display device 10 includes a touch panel 100, a display panel 200, an anti-splinted film 300 and a transparent conductive layer 400. The anti-splinted film 300 is disposed between the touch panel 100 and the display panel 200. The transparent conductive layer 400 is disposed between the display panel 200 and the anti-splinted film 300. In this embodiment, the touch display device 10 further includes a first adhesion layer 500 and a second adhesion layer 600.

The touch panel 100 includes a substrate 110 and a plurality of first sensing pads 120, a plurality of second sensing pads (not shown), a plurality of first bridge lines 122, a plurality of second bridge lines 132, a fan-out circuit 140, a black sealant 150, a patterned passivation layer 160 and a passivation layer 170 which are disposed on the substrate 110, for example. In this embodiment, the substrate 110 is, for example, a glass substrate, and can be served as a cover lens. The first sensing pads 120 are, for example, rectangular sensing pads. A material of the first sensing pads 120 is transparent conductive material such as indium tin oxide (ITO), for example. The first bridge lines 122 are disposed between the first sensing pads 120 to connect two adjacent first sensing pads 120. The first sensing pads 120 and the first bridge lines 122 form a plurality of first sensing series 118 extended along a first direction D1. In this embodiment, a material of the first bridge lines 122 is transparent conductive material such as indium tin oxide (ITO), for example. Similarly, the second sensing pads can also be rectangular sensing pads. A material of the second sensing pads is transparent conductive material such as indium tin oxide (ITO), for example. The second bridge lines 132 are disposed between the second sensing pads to connect two adjacent second sensing pads. The second sensing pads and the second bridge lines 132 form a plurality of second sensing series (not shown) extended along a second direction (not shown). A material of the second bridge lines 132 is transparent conductive material such as indium tin oxide (ITO), for example. In this embodiment, a plurality of first sensing series 118 are parallel to each other, a plurality of second sensing series are parallel to each other, and the first direction D1 is perpendicular to the second direction, for example. The first sensing series 118 and the second sensing series are crossover at the overlapping regions of the first bridge lines 122 and the second bridge lines 132. The patterned passivation layer 160 is disposed between the first bridge lines 122 and the second bridge lines 132, so that the first sensing series 118 and the second sensing series are electrically insulated from each other.

The fan-out circuit 140 is electrically connected to the first sensing series 118, for example. A material of the fan-out circuit 140 can be substantially the same as or different from the material of the sensing pads 120. The black sealant 150 is, for example, disposed on a periphery of the substrate 110. The passivation layer 170 covers the first sensing series 118, the second sensing series, the fan-out circuit 140, and the black sealant 150. In this embodiment, the fan-out circuit 140 is made of an opaque conductive material, for example, and thus the fan-out circuit 140 is preferably formed on the black sealant 150. Accordingly, the disposition of the fan-out circuit 140 does not cause the reduction of the aperture ratio of the touch display device 10. It is noted that, in the added type touch panels, sensing series are formed on a substrate and the substrate is then adhered to a cover lens having a black sealant formed thereon, and therefore the thickness and the weight of the added type touch panels are difficult to reduce. In this embodiment, the sensing series 118 and the black sealant 150 are fabricated on the substrate 110 serving as a cover lens. Therefore, the thickness of the touch panel 100 is greatly reduced, and the touch display device 10 has features of being light and thin.

The display panel 200 includes, for example, a pixel array substrate 210, a color filter substrate 220, a display medium 230, a first polarization plate 240, and a second polarization plate 250. In this embodiment, the pixel array substrate 210 includes a first substrate 212 and a pixel array layer 214 disposed on the first substrate 212, for example. The first substrate 212 may be a glass substrate. The pixel array layer 214 includes a plurality of scan lines (not shown), a plurality of data lines (not shown), and a plurality of pixel structures arranged in array (not shown), wherein the pixel structure is electrically connected to a corresponding scan line and a corresponding data line through an active device. The color filter substrate 220 is disposed opposite to the pixel array substrate 210. The color filter substrate 220 includes a second substrate 222 and a color filter layer 224 disposed on the second substrate 222, for example. The second substrate 222 can be a glass substrate. The color filter layer 224 includes a plurality of color filter patterns (not shown) and a black matrix (not shown). The display medium 230 is located between the pixel array substrate 210 and the color filter substrate 220. The display medium 230 is, for example, a liquid crystal layer. The first polarization plate 240 is, for example, disposed on the second substrate 222, and thus the color filter substrate 220 is disposed between the first polarization plate 240 and the display medium 230. The second polarization plate 250 is, for example, disposed on the first substrate 212, and thus the pixel array substrate 210 is disposed between the second polarization plate 250 and the display medium 230.

The anti-splinted film 300 includes a hard coating layer 310 and an anti-splinted layer 320, for example. In this embodiment, the hard coating layer 310 has a first surface 312 and a second surface 314 which are opposite to each other, wherein the first surface 312 is close to the touch panel 100, and the second surface 314 is close to the display panel 200. The anti-splinted layer 320 is disposed on the first surface 312 of the hard coating layer 310, for example. A material of the anti-splinted layer 320 can be polyethylene terephthalate (PET), and a forming method of the anti-splinted layer 320 is a coating method, for example. In this embodiment, the first adhesion layer 500 is disposed between the anti-splinted film 300 and the touch panel 100, so as to adhere the anti-splinted film 300 to the touch panel 100, for example. In detail, the first adhesion layer 500 is in contact with the anti-splinted layer 320 and the touch panel 100 respectively, to adhere the anti-splinted film 300 and the touch panel 100. Thus, the touch panel 100 is prevented from being fractured when stressed by external pressure.

In this embodiment, the transparent conductive layer 400 is formed on the second surface 314 of the hard coating layer 310, for example. A method of forming the transparent conductive layer 400 is, for example, a sputtering method. A material of the transparent conductive layer 400 is, for example, indium tin oxide (ITO), indium zinc oxide (IZO), Al doped ZnO (AZO), indium-gallium-zinc oxide (IGZO), Ga doped zinc oxide (GZO), zinc-tin oxide (ZTO), In₂O₃, ZnO, or SnO₂. When the touch display device 10 is operated, the transparent conductive layer 400 is grounded, for example.

In the embodiment, the second adhesion layer 600 is, for example, an optical adhesive, and disposed between the display panel 200 and the transparent conductive layer 400. In other words, after the anti-splinted layer 320 and the transparent conductive layer 400 are respectively formed on the first surface 312 and the second surface 314 of the hard coating layer 310, the anti-splinted film 300 is adhered to the touch panel 100 through the first adhesion layer 500. Then, the touch panel 100, the anti-splinted film 300, and the transparent conductive layer 400 are adhered to the display panel 200 through the second adhesion layer 600. As a result, assembling of the touch display device 10 is completed. In this embodiment, after assembling the touch panel 100, the anti-splinted film 300, the transparent conductive layer 400, and the display panel 200, the transparent conductive layer 400 covers on the display panel 200 entirely, for example. It is mentioned that, since the second adhesion layer 600 is coated on the periphery of the first polarization plate 240 of the display panel 200 as shown in FIG. 1, air may exist in the region between the transparent conductive layer 400 and the center of the first polarization plate 240, which is not coated by the second adhesion layer 600. In other words, the transparent conductive layer 400 and the display panel 200 may be substantially air bonding, for example.

Generally speaking, in touch panels, the signals are generated when the capacitance between the sensing pads is changed. However, in the touch display device, the data lines of the touch panel may couple with the sensing pads of the display panel to form a parasitic capacitance and cause signal interference. Accordingly, the signal received by the sensing pads is likely to be interfered, and the sensing capacity of the sensing pads is deteriorated. In this embodiment, by forming the transparent conductive layer 400 on the anti-splinted film 300, the transparent conductive layer 400 is disposed between the touch panel 100 and the display panel 200. Therefore, when voltage is applied on the data lines of the display panel 200, the data lines may couple with the transparent conductive layer 400, rather than couple with the sensing pads 120 of the touch panel 100. In other words, since the sensing pads 120 of the touch panel 100 are shielded from the data lines of the display panel 200 by the transparent conductive layer 400, the coupling between the data lines and the sensing pads 120 of the touch panel 100 is prevented. Accordingly, the arrangement of the transparent conductive layer 400 can prevent signal interference causing from a side of the display panel 200, and thus the sensing capacity of the sensing pads 120 is improved. Therefore, the present embodiment is conducive to reducing the noise, and the signal to noise ratio (SNR) and the sensing capacity of the touch display device 10 are improved.

### Second Embodiment

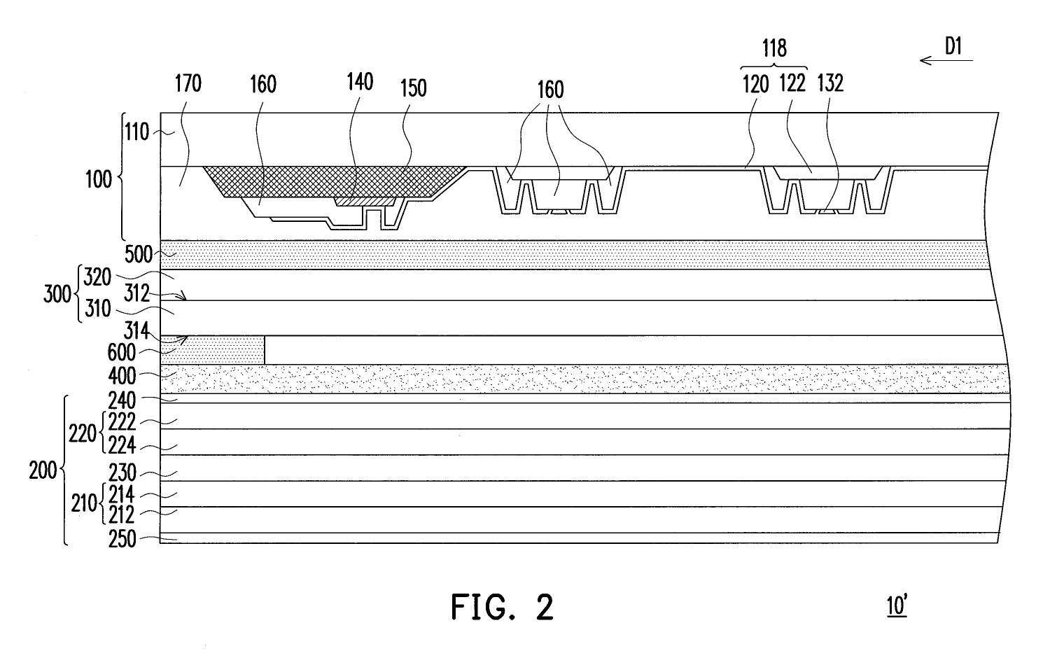

FIG. 2 is a schematic cross-sectional view illustrating a touch display device according to a second embodiment of the invention. The main components of the touch display device 10′ shown in FIG. 2 are substantially the same as the main components of the touch display device 10 shown in FIG. 1, and the differences are illustrated in the following. In this embodiment, the transparent conductive layer 400 is disposed between the display panel 200 and the anti-splinted film 300, and the transparent conductive layer 400 is disposed between the display panel 200 and the second adhesion layer 600, for example. The transparent conductive layer 400 is, for example, formed on the first polarization plate 240 of the display panel 200. In detail, after the transparent conductive layer 400 is disposed on the display panel 200, the anti-splinted film 300 is adhered to the touch panel 100 through the first adhesion layer 500. Then, through the second adhesion layer 600, the anti-splinted film 300 and the touch panel 100 are adhered to the display panel 200 with the transparent conductive layer 400 formed thereon. As a result, assembling of the touch display device 10′ is completed. In this embodiment, the transparent conductive layer 400 is formed by sputtering method, for example. A material of the transparent conductive layer 400 is, for example, indium tin oxide (ITO), indium zinc oxide (IZO), Al doped ZnO (AZO), indium-gallium-zinc oxide (IGZO), Ga doped zinc oxide (GZO), zinc-tin oxide (ZTO), In₂O₃, ZnO, or SnO₂. When the touch display device 10′ is operated, the transparent conductive layer 400 is grounded, for example.

In this embodiment, the transparent conductive layer 400 is disposed between the touch panel 100 and the display panel 200 by forming the transparent conductive layer 400 on the display panel 200. Therefore, the data lines may couple with the transparent conductive layer 400 when voltage is applied on the data lines of the display panel 200. Since the sensing pads 120 of the touch panel 100 are shielded from the data lines by the transparent conductive layer 400, the coupling between the data lines of the display panel 200 and the sensing pads 120 of the touch panel 100 is prevented. In other words, the arrangement of the transparent conductive layer 400 can prevent signal interference causing from a side of the display panel 200, and thus the sensing signal generated by the sensing pads 120 is not interfered. Accordingly, the present embodiment is conducive to reducing the noise, and the signal to noise ratio (SNR) and the sensing capacity of the touch display device 10′ are improved.

It should be noted that, although the above embodiments exemplarily describe that the touch display device has an anti-splinted film therein, the invention is not limited thereto. In other words, in other embodiments, the touch display device, where the transparent conductive layer is disposed therein to serve as a shielded layer, may not include an anti-splinted film.

### Third Embodiment

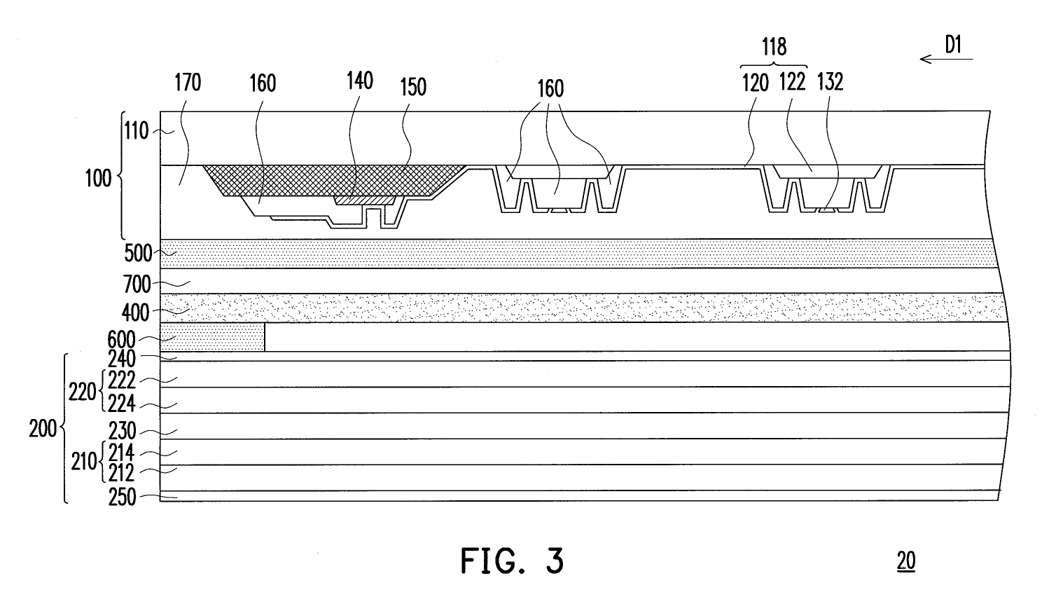

FIG. 3 is a schematic cross-sectional view illustrating a touch display device according to a third embodiment of the invention. Referring to FIG. 3, a touch display device 20 includes a touch panel 100, a display panel 200, a transparent substrate 700 and a transparent conductive layer 400. The transparent substrate 700 is disposed between the touch panel 100 and the display panel 200. The transparent conductive layer 400 is disposed between the transparent substrate 700 and the display panel 200. In this embodiment, the touch display device 20 further includes a first adhesion layer 500 and a second adhesion layer 600. The structure and components of the touch panel 100 and the touch panel 200 shown in FIG. 3 are similar to those provided in the first embodiment, and thus further descriptions are omitted.

In this embodiment, the transparent conductive layer 400 is disposed on the transparent substrate 700, for example. The transparent substrate 700 may be a glass substrate. The method of forming the transparent conductive layer 400 is, for example, a sputtering method. A material of the transparent conductive layer 400 is, for example, indium tin oxide (ITO), indium zinc oxide (IZO), Al doped ZnO (AZO), indium-gallium-zinc oxide (IGZO), Ga doped zinc oxide (GZO), zinc-tin oxide (ZTO), In₂O₃, ZnO, or SnO₂. In this embodiment, after the transparent conductive layer 400 is formed on the transparent substrate 700, the transparent substrate 700 and the transparent conductive layer 400 are together adhered to the touch panel 100 through the first adhesion layer 500. Then, through the second adhesion layer 600, the touch panel 100, the transparent substrate 700 and the transparent conductive layer 400 are adhered to the display panel 200, thereby the assembling of the touch display device 20 is completed. When the touch display device 20 is operated, the transparent conductive layer 400 is grounded, for example.

In this embodiment, the transparent conductive layer 400 is disposed between the touch panel 100 and the display panel 200. Therefore, the data lines may couple with the transparent conductive layer 400 when voltage is applied on the data lines of the display panel 200. Since the sensing pads 120 of the touch panel 100 are shielded from the data lines by the transparent conductive layer 400, the coupling between the data lines of the display panel 200 and the sensing pads 120 of the touch panel 100 is prevented. In other words, the arrangement of the transparent conductive layer 400 can prevent signal interference causing from a side of the display panel 200, and thus sensing signal generated by the sensing pads 120 is not interfered. Accordingly, the present embodiment is conducive to reducing the noise, and the signal to noise ratio (SNR) and the sensing capacity of the touch display device 20 are improved.

It should be noted that, although the above embodiments exemplarily describe that the touch panel 100 and the display panel 200 have structure shown in FIGS. 1 to 3, the invention is not limited thereto. In other words, the touch panel 100 and the display panel 200 may have other components or configurations, as long as the transparent conductive layer 400 is disposed between the touch panel 100 and the display panel 200.

According to the touch display device of the exemplary embodiments of the invention, the transparent conductive layer is disposed between the touch panel and the display panel, and the sensing pads of the touch panel are shielded from the data lines by the transparent conductive layer. Therefore, the data lines of the display panel may couple with the transparent conductive layer, rather than couple with the sensing pads of the touch panel, and the coupling between the data lines of the display panel and the sensing pads of the touch panel is prevented. Accordingly, signal interference caused by the data lines of the display panel on the sensing pads is avoided, noise is lowered, and the sensing capacity of the sensing pads is improved. Thus, the signal to noise ratio (SNR) and the sensing capacity of the touch panel are improved. Moreover, in an embodiment, the sensing series and the black sealant can be fabricated on the same substrate which serves as a cover lens. Therefore, the thickness of the touch panel is greatly reduced, and the touch display device has features of being light and thin.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch display device comprising:
a touch panel;
a display panel;
an anti-splinted film, disposed between the touch panel and the display panel; and
a transparent conductive layer, disposed between the display panel and the anti-splinted film.

2. The touch display device as claimed in claim 1, wherein a material of the anti-splinted film comprises polyethylene terephthalate (PET).

3. The touch display device as claimed in claim 1, further comprising a first adhesion layer disposed between the anti-splinted film and the touch panel.

4. The touch display device as claimed in claim 3, further comprising a second adhesion layer disposed between the display panel and the transparent conductive layer.

5. The touch display device as claimed in claim 3, further comprising a second adhesion layer disposed between the transparent conductive layer and the anti-splinted film.

6. The touch display device as claimed in claim 5, wherein the display panel comprises:
a pixel array substrate;
a color filter substrate, disposed above the pixel array substrate;
a display medium, disposed between the pixel array substrate and the color filter substrate; and
a first polarization plate, wherein the color filter substrate is disposed between the first polarization plate and the display medium.

7. The touch display device as claimed in claim 6, wherein the transparent conductive layer is disposed between the first polarization plate and the first adhesion layer.

8. A touch display device comprising:
a touch panel;
a display panel;
a transparent substrate, disposed between the touch panel and the display panel; and
a transparent conductive layer, disposed between the transparent substrate and the display panel.

9. The touch display device as claimed in claim 8, further comprising a first adhesion layer disposed between the display panel and the transparent conductive layer.

10. The touch display device as claimed in claim 8, further comprising a second adhesion layer disposed between the transparent substrate and the touch panel.
